(19) United States
(12) Patent Application Publication
(10) Pub. No.: US 2009/0193881 A1
(43) Pub. Date: Aug. 6, 2009

(54) Method, Apparatus, and Nanoindenter for Determining an Elastic Ratio of Indentation Work

(76) Inventor: Jorg Finnberg, Dresden (DE)

Correspondence Address: COATS & BENNETT/QIMONDA, 1400 CRESCENT GREEN, SUITE 300, CARY, NC, 27518, US

(21) Appl. No.: 12/023,271

(22) Filed: Jan. 31, 2008

(51) Int. Cl. G01N 3/48; G01B 5/18

(52) U.S. Cl. 73/81; 702/166

(57) ABSTRACT

A method for determining an elastic ratio of indentation work of an indentation of a material surface to a sampling depth is described. The method may include: placing an indenter probe on the material surface; indenting the material surface to a maximum depth greater than the sampling depth by increasing a vertical force on the probe, while recording the force as a first function of depth; retracting the probe from the material surface by decreasing the force, while recording the force as a second function of depth; and calculating the elastic ratio of indentation work for the sampling depth from the recorded functions.

### BACKGROUND OF THE INVENTION

1. Field of Invention

This invention relates generally to a method for determining an elastic ratio of indentation work, as well as to a computer program product for performing such a method. Furthermore, the invention also relates to a nanoindenter and an apparatus for determining an elastic ratio of indentation work.

2. Related Art

The development of nanostructured materials, thin films, surface coatings, miniaturized electronic and engineering components etc. benefits from a detailed understanding of the mechanical properties of materials at the nanoscale. For example, in the experimental technique of nanoindentation a load is applied to an indenter probe placed against a surface of a material to be investigated. Typically, the load is increased during a loading phase until the probe has penetrated the material to a maximum depth of penetration, and decreased during an unloading phase following the loading phase.

One material property obtainable by nanoindentation experiments is the elastic ratio of indentation work (ηIT), which specifies the share of the mechanical work applied to the probe during the loading phase that is recoverable as elastic energy during the unloading phase. In order to determine the elastic ratio of indentation work as a function of the maximum depth of penetration, a series of independent experiments may be performed, indenting the investigated material in each experiment to a different maximum depth of penetration.

### SUMMARY

A method for determining an elastic ratio of indentation work of an indentation of a material surface to a sampling depth is described. The method may include: placing an indenter probe on the material surface; indenting the material surface to a maximum depth greater than the sampling depth by increasing a vertical force on the probe, while recording the force as a first function of depth; retracting the probe from the material surface by decreasing the force, while recording the force as a second function of depth; and calculating the elastic ratio of indentation work for the sampling depth from the recorded functions.

Additionally, an apparatus for determining an elastic ratio of indentation work of an indentation of a material surface to a sampling depth is also described. The apparatus may include: a load curve data input unit for inputting load curve data that represent a load force measured on an indenter probe indenting the material surface up to a maximum depth greater than the sampling depth, in dependence on a depth indented to; an unload curve data input unit for inputting unload curve data that represent an unload force measured on the indenter probe while retracting from the material surface from the maximum depth, in dependence on a depth retracted to; and a calculation unit for calculating the elastic ratio of indentation work for the sampling depth from the inputted data.

Other systems, methods features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 shows a schematic view of a nanoindenter according to an approach, including a material surface to be indented;

FIG. 2A shows load and unload curves for an indentation acquired by the nanoindenter of FIG. 1, with a sampling depth marked;

FIG. 2B shows the load and unload curves of FIG. 2A, with an unload curve shifted along a depth axis;

FIG. 3A shows the load and unload curves for an indentation acquired by a nanoindenter according to a further approach, with a sampling depth marked;

FIG. 3B shows the load and unload curves of FIG. 3A, with an unload curve shifted along a force axis according to a method of an approach;

FIG. 3C shows the load and unload curves of FIG. 3A, with the shifted unload curve extrapolated according to a method of an approach;

FIG. 4 shows a flow diagram of a method for determining an elastic ratio of indentation work according an approach;

FIG. 5 shows an example of a layered material surface to be investigated in an indentation experiment; and

FIG. 6 shows a graph of an elastic ratio of indentation work as a function of penetration depth determined according to an approach.

### DETAILED DESCRIPTION

In the following description, reference is made to the accompanying drawings that form a part hereof, and in which is shown by way of illustration one or more specific implementations in which the invention may be practiced. It is to be understood that other implementations may be utilized and structural changes may be made without departing form the scope of this invention.

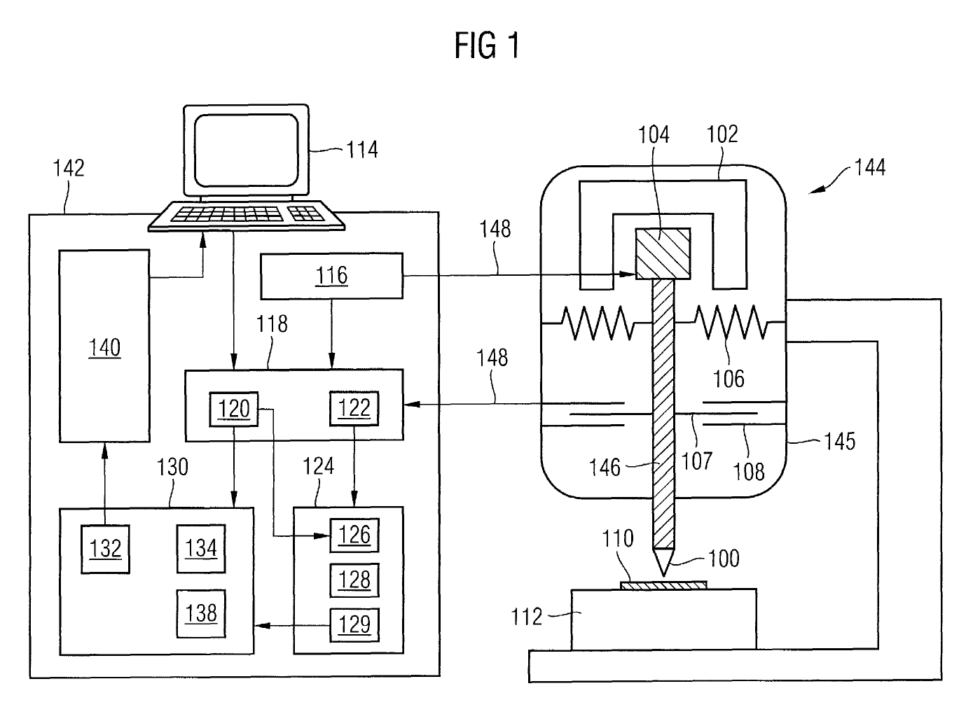

FIG. 1 shows a schematic view of a nanoindenter 144, 142 according to an approach. The nanoindenter 144, 142 comprises an indentation unit 144 in which a material surface 110 to be investigated by undergoing indentation is placed on a mount 112, and a data processing unit 142 for controlling the indentation unit 144 during the investigation of the material surface 100, as well as acquiring and processing data from the indentation unit 144.

The indentation unit 144 comprises an indentation probe 100 mounted on a shaft 146 that is held in a stable position by a pair of springs 106. At the end of the shaft opposing the indentation probe, a coil 104 is mounted on the shaft 146 and positioned between the poles of a permanent magnet 102. The coil 104 and magnet 102 together form an indentation force drive, which, when electric current is passed through the coil 104 exerts a force through the shaft 146 onto the indentation probe 100. To the shaft 146, capacitor plates 107 are attached that move with the shaft 146 between corresponding static capacitor plates 108 attached to a housing 145 of the indentation unit 144. The moving 107 and static 108 capacitor plates form a position detector 107, 108 for detecting the position of the indentation probe 100 mounted to the shaft 146.

The data processing unit 142 is connected to the indentation unit 144 through data lines 148. In alternative approaches, data processing unit 142 and indentation unit 144 are arranged in a common housing, or connected to each other via wireless data links instead of the data lines 148.

The data processing unit 142 comprises a controller unit 116 for controlling the movement of the indenter probe 100 in the indentation unit 144. For this purpose, the controller unit 116 is connected to the coil 104 of the indentation unit. The data processing unit 142 further comprises a recorder unit 118 for simultaneously recording a position of the indenter probe 100 and the force exerted on the probe 100 by the indentation force drive 102, 104. For this purpose, the recorder unit 118 is connected both to the position detector 107, 108 in the indentation unit 146 and to the controller unit 116. The recording unit 118 comprises a load curve data input unit 120 for recording load curve data comprising data pairs of the depth of penetration of the indenter probe 100 into the material surface 110 during motion of the indenter probe 100 towards the material surface 110, and a load curve data input unit 122 for recording unload curve data equally comprising data pairs of the depth of penetration of the indenter probe 100 into the material surface 110 during motion of the indenter probe 100 away from the material surface 110.

The recorder unit 118 is furthermore connected to a data console 114 from where load and unload curve data can also be received, alternatively to acquiring such data from the controller unit 116 and the position detector 107, 108. For example, data acquired in earlier experiments or using different indentation units can be inputted through the data console 114. When used in such a way, the data processing unit 142 functions as an apparatus 142 for determining an elastic ratio of indentation work in itself, without including the indentation unit 144.

The data processing unit 142 further comprises an unload curve shifting unit 124 for modifying the unload curve data recorded by the unload curve data input unit 122. The unload curve shifting unit 124 comprises a load curve evaluator 126 for determining a sampling depth indentation force by evaluating the load curve at the sampling depth. Further, it comprises a sampling retraction depth determiner 128 for determining a sampling retraction depth at which the unload curve evaluates to the sampling depth indentation force. Further, the unload curve shifting unit 124 comprises a function redefiner 129 for redefining the unload curve such that it evaluates at a given depth to the force value of the unmodified unload curve evaluated for the sum of the depth and the difference of the sampling depth and the sampling retraction depth.

The data processing unit 142 further comprises a calculation unit 130 for calculating a value of the elastic ratio of indentation work for a desired sampling depth of penetration. The calculation unit 130 receives the modified unload curve from the unload curve shifting unit 124 and the unmodified load curve from the recorder unit 118. The calculation unit 130 comprises a load curve integrator 138 for integrating the first function in an interval up to the sampling depth, thus determining an overall indentation work of the indenter probe during the loading phase. Further, the calculation unit 130 comprises an unload curve integrator 134 for integrating the second function in the interval up to the sampling depth, thus determining an elastic indentation energy that is recovered when the indenter probe is unloaded. Further, the calculation unit 130 comprises a divider 132 for dividing the elastic indentation work by the overall indentation work, thus arriving at a value of the elastic ratio of indentation work for the sampling depth.

Finally, the data processing unit 142 comprises an adjustment unit 140, for adjusting the value of the elastic ratio of indentation work calculated by the calculation unit 130, based in alternative approaches e.g. on experimental data of an indentation to and retraction from substantially the sampling depth, or on theoretical models of nanoindentation processes, or both. The adjustment unit 140 is connected to the data console 114 for outputting the adjusted value of the elastic ratio of indentation work.

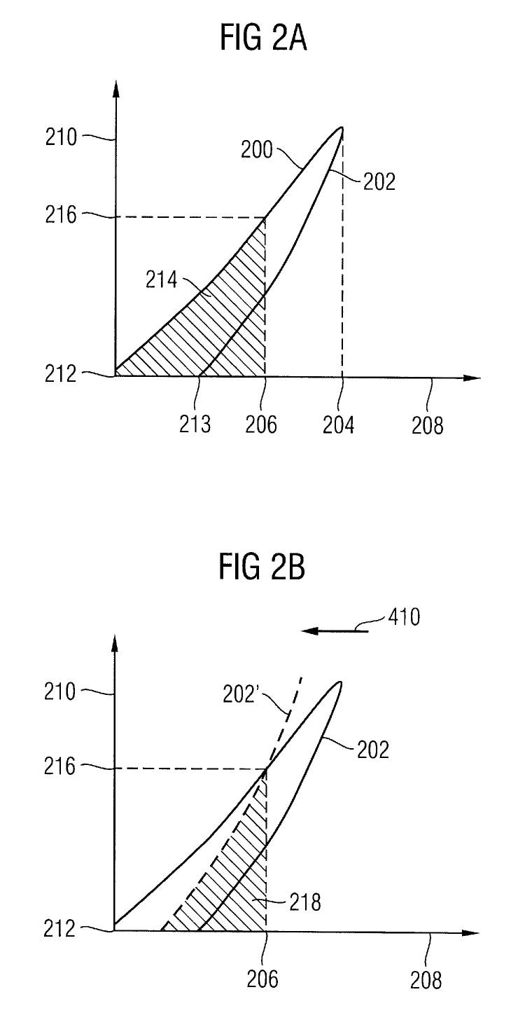

In the following, calculations carried out in the calculation unit 130 and the unload curve shifting unit 124 of the approach of FIG. 1 will be explained in further detail by referring to FIGS. 2A and B.

FIG. 2A shows a coordinate system with load 200 and unload 202 curves of an indentation experiment carried out by the nanoindenter of FIG. 1. The load force on the indenter probe is plotted along the vertical axis 210, and the penetration depth along the horizontal axis 208. The indentation experiment starts at the origin 212 of the coordinate system with the indenter probe placed at the surface of the material to be investigated. The load on the probe is then gradually increased, thereby pushing the probe into the material, with force and penetration depth following the load curve 200 until a maximum penetration depth 204 is reached. From there, the load on the probe is gradually decreased, resulting in the indenter probe being pushed backwards by the elastic response of the material, following the unload curve 202. Since not all of the indentation work of the load phase 200 is recoverable as elastic energy, the unload curve 202 lies below the load curve 200. The unload curve reaches the depth axis at a residual depth 213, where the elastic material force pushing the probe backward becomes zero.

The overall indentation work performed by the nanoindenter during the loading phase 200 is given by the area under the load curve 200 in the interval between a depth of zero 212 and the maximum penetration depth 204. The elastic indentation work recovered by the nanoindenter during the unloading phase 202 correspondingly is given by the area under the unload curve 202 in the interval from the residual depth 213 to the maximum penetration depth 204, or alternatively in the interval from zero depth 212 to the maximum penetration depth 204 when assuming that the unload curve follows the depth axis 208 for depth values less than the residual depth 213. Thus, the elastic ratio of indentation work for the particular material and maximum penetration depth 204 can be calculated by dividing the elastic indentation work by the overall indentation work.

Also, the overall indentation work performed by the nanoindenter during the loading phase 200 up to an arbitrary sampling depth 206 and associated load 216 that is less than the maximum penetration depth is given by the area 214 under the load curve 200 in the interval between a depth of zero 212 and the sampling depth 206. The area under the unload curve 202 in the same interval however is different from an area that would be obtainable in an indentation experiment with maximum penetration at the sampling depth 206. Thus, an approach in which the unload curve 202 is adjusted to resemble an unload curve obtainable in an indentation experiment with maximum penetration at the sampling depth 206 may have an effect of enabling to calculate a value of the elastic ratio of indentation work that is a particularly close approximation of the elastic ratio of indentation work obtainable from the indentation experiment with maximum penetration at the sampling depth 206.

As shown in FIG. 2B, in the present approach the unload curve 202 is shifted 410 to the left along the depth axis 208 to a shifted position 202′, by such an amount that the shifted curve 202, intersects the load curve 200 at the sampling depth 206 and associated load 216. Now, the area 218 under the shifted curve 202′ in the interval up to the sampling depth 206 is determined to obtain a value for the elastic indentation work that approximates a value obtainable from the indentation experiment with maximum penetration at the sampling depth 206. A value for the elastic ratio of indentation work is then calculated by dividing the marked area 218 in FIG. 2B by the marked area 214 in FIG. 2A.

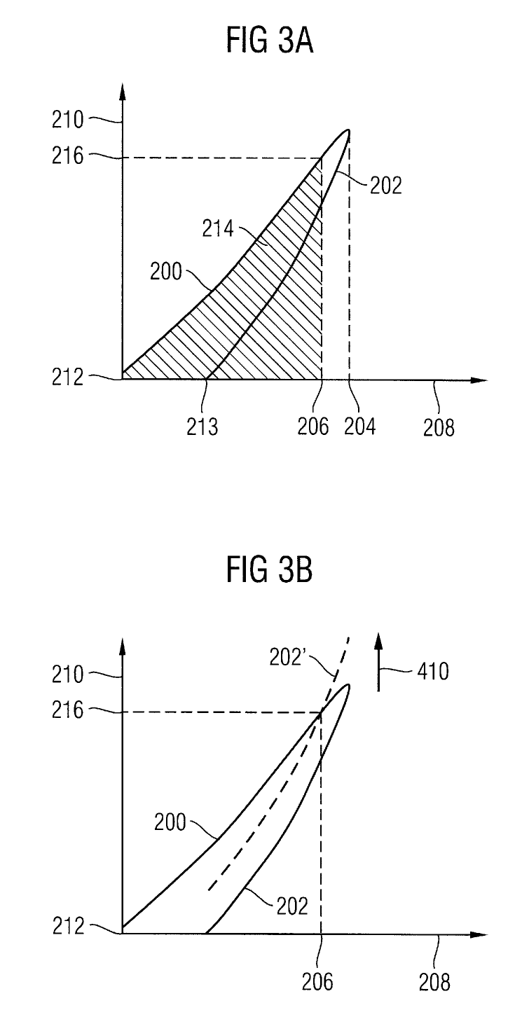

FIG. 3A shows a coordinate system with load 200 and unload 202 curves of an indentation experiment carried out by a nanoindenter according to another approach. As in FIG. 2A, the load force on the indenter probe is plotted along the vertical axis 210, and the penetration depth along the horizontal axis 208. The indentation experiment starts at the origin 212 of the coordinate system, with load force on the indenter probe and penetration depth following the load curve 200 until the maximum penetration depth 204 is reached. From there, the load on the probe is gradually decreased, following the unload curve 202, until a load of zero is reached at the residual depth 213. A sampling depth 206 smaller than the maximum penetration depth 204 has been marked, as well as a corresponding load 216 at the sampling depth 206 during the loading phase.

In order to determine from these experimental data, a value for the elastic ratio of indentation work that approximates an elastic ratio of indentation work derivable from an indentation experiment with the sampling depth 206 as maximum penetration depth, the function 200 of depth 208 corresponding to the load curve 200 is integrated in the interval between zero depth 212 and the sampling depth 206 to obtain the overall indentation work 214 performed during the loading phase 200 up to the sampling depth 206.

In FIG. 3B, the unload curve 202 has been shifted 410 vertically along the force axis 210; such that the shifted unload curve 202′ intersects the load curve 200 at the sampling depth 206. In FIG. 3C, the shifted unload curve 202′ is extrapolated 300 to the depth axis 208 by a suitable curve fitting algorithm. The function 200 of depth 208 corresponding to the shifted and extrapolated unload curve 202′, 300 is then integrated in the interval between an approximated residual depth 213′ at which the extrapolated portion 300 reaches the depth axis 208 and the sampling depth 216. A value for the elastic ratio of indentation work is then calculated by dividing the marked area 218 corresponding to the result of the integration in FIG. 3C by the marked area 214 in FIG. 3A.

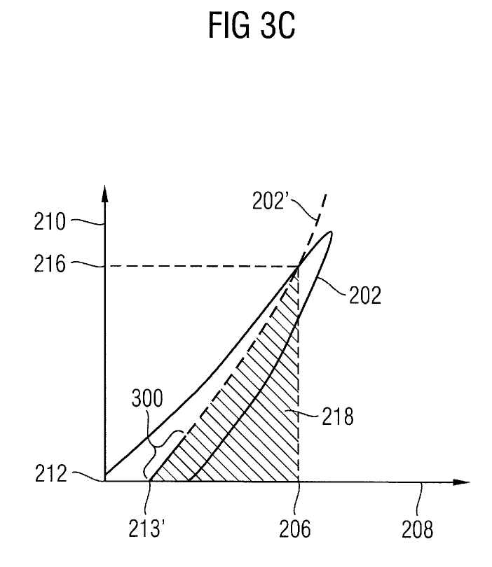

FIG. 4 shows a flow diagram of a method for determining an elastic ratio of indentation work according to an approach. In step 400, a maximum penetration depth is chosen for an indentation experiment to be performed on a surface of a material, based e.g. on an intended application of the material. In alternative approaches, a maximum load force is chosen, thus determining implicitly the maximum penetration depth.

In step 402, an indenter probe is placed at the surface of the material such that it touches the surface but does not exert any force. In a loading phase 404, a load on the indenter probe is gradually increased such that the indenter probe gradually penetrates the material until the maximum penetration depth (or maximum load) chosen in step 400 is reached. During the loading phase 404, the load on the indenter probe is recorded as a first function of penetration depth.

In an unloading phase 406, the load on the indenter probe is gradually decreased again such that the indenter probe gradually retracts from the material towards the surface until a residual depth at which the load on the probe reaches zero. During the unloading phase 406, the load on the indenter probe is recorded as a second function of penetration depth.

In step 408 a sampling depth is selected for which an elastic ratio of indentation work is to be calculated in the following steps 410-418. In the present approach, the range between a depth of zero and the maximum penetration depth reached in the loading phase 404 is divided into a predetermined number of intervals, from which the higher bound of the first interval is chosen as sampling depth.

In step 410 the second function of depth, recorded during the unload phase 406 is shifted along the depth axis such that it evaluates at the sampling depth to the same force value as the first function of depth, recorded during the loading phase 404. In alternative approaches, the second function is shifted along the force axis or along both axes.

In step 412 the first function of depth is integrated in the interval between a depth of zero and the sampling depth, yielding a value for the overall indentation work performed up to the sampling depth during the loading phase 404. In step 414 the second function of depth as modified in step 412 is integrated in the interval between a depth of zero and the sampling depth, yielding a value for the elastic energy portion of the overall indentation work performed up to the sampling depth during the loading phase 404. In step 418 the value for the elastic energy portion determined in step 414 is divided by the value for the overall indentation work determined in step 412, yielding a value for the elastic ratio of indentation work corresponding to the sampling depth selected in step 408.

In step 420 it is determined whether further values of the elastic ratio of indentation work values corresponding to further values of the sampling depth are to be calculated. If this is the case, the method branches to step 408 where a new value for the sampling depth is selected from the range between zero and the maximum penetration depth, by choosing the higher bound of the next interval as sampling depth. A further value of the elastic ratio of indentation work that corresponds to the new sampling depth selected in step 408 is then calculated in steps 410-418. This is repeated until values for the elastic ratio of indentation work corresponding to the respective higher bounds of all intervals in the range between zero and the maximum penetration depth have been calculated.

Step 420 then branches to step 422, wherein the calculated values are further adjusted based on an empirical or theoretical comparison of elastic ratio of indentation work results determined according to the present approach and elastic ratio of indentation work values determined in a conventional series of separate indentation experiments in each of which the surface of the material is indented to a different sampling depth as maximum depth of penetration. In step 424, the series of elastic ratio of indentation work values calculated in steps 408-420 and adjusted in step 422 is output as a function that provides the elastic ratio of indentation work as a function of sampling depth in the range between zero and the maximum penetration depth of the loading phase 404.

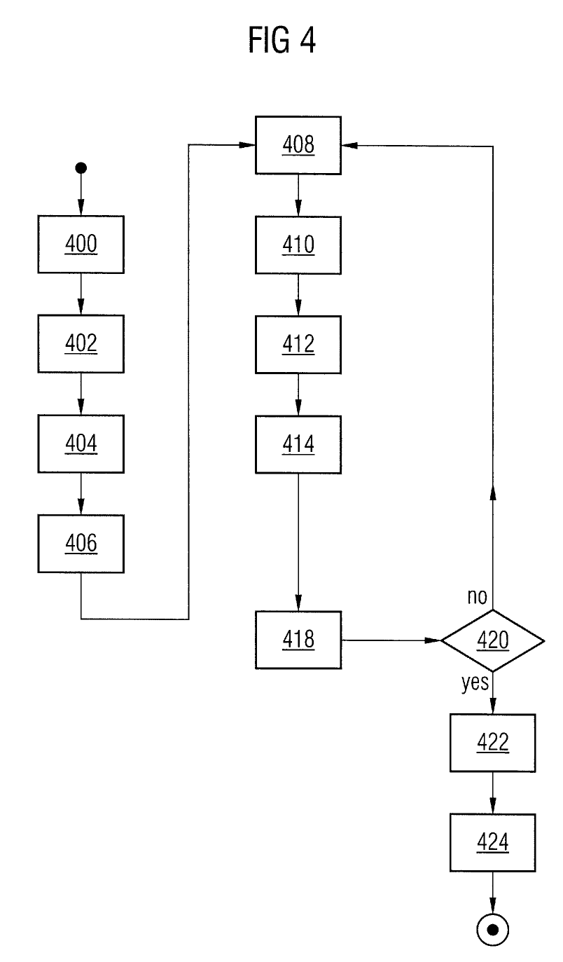

FIG. 5 shows an example of a layered material surface 100 to be investigated in an indentation experiment. The material 115/110 comprises a substrate layer 504, an intermediate layer 502, and a top layer 500. An indentation probe 100 during a loading phase 404 of an indentation experiment first penetrates the top layer 500 before entering the intermediate layer 502 through the interface 604 between the top and intermediate layers. Before reaching the substrate 504, the indentation probe 100 is retracted in an unload phase 406.

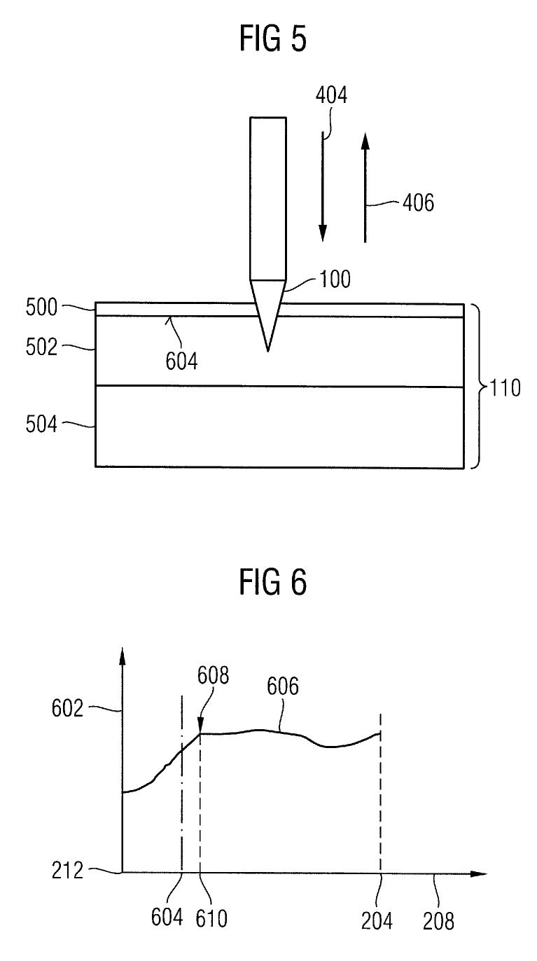

FIG. 6 shows a graph of an elastic ratio of indentation work 602 as a function 606 of penetration depth 208 determined in the indentation experiment of FIG. 5. The elastic ratio of indentation work 602 is displayed as a function of sampling depth 208 in the range between zero 212 and the maximum penetration depth 204 of the loading phase 404. A distinct change 608 in the slope of the function 606 may be suggestive of a change of structure or composition of the material at or close to a corresponding depth 610. For comparison only, the dash-dotted line marks the thickness of the top layer 500 in the non-indented material, i.e. the distance of the interface 604 between the top and intermediate layers from the surface of the non-indented material.

What is claimed is:

1. A method for determining an elastic ratio of indentation work of an indentation of a material surface to a sampling depth, the method comprising:
placing an indenter probe on the material surface;
indenting the material surface to a maximum depth greater than the sampling depth by increasing a vertical force on the probe, while recording the force as a first function of depth;
retracting the probe from the material surface by decreasing the force, while recording the force as a second function of depth; and
calculating the elastic ratio of indentation work for the sampling depth from the recorded functions.

2. The method of claim 1, wherein the elastic ratio of indentation work for the sampling depth is calculated from the first and second functions in an interval up to the sampling depth.

3. The method of claim 1, wherein the step of calculating the elastic ratio of indentation work comprises:
determining an overall indentation work by integrating the first function in an interval up to the sampling depth;
determining an elastic indentation work by integrating the second function in the interval up to the sampling depth; and
calculating the elastic ratio of indentation work for the sampling depth by dividing the elastic indentation work by the overall indentation work.

4. The method of claim 1, further comprising:
determining a sampling depth indentation force by evaluating the first function at the sampling depth;
determining a sampling retraction depth at which the second function evaluates to the sampling depth indentation force;
modifying the second function of depth, such that it evaluates to the force value of the unmodified second function after a difference of the sampling depth and the sampling retraction depth is added to the depth.

5. The method of claim 1, further comprising:
determining a shift term by subtracting the value of the second function at the sampling depth from the value of the first function at the sampling depth; and
shifting the second function by adding the shift term to the second function.

6. The method of claim 5, further comprising:
determining a residual depth at which the second function assumes a force value of zero; and
extrapolating the shifted second function in an interval up to the residual depth, down to a force value of zero of the extrapolated second function.

7. The method of claim 1, wherein the calculated elastic ratio of indentation work is adjusted by an adjustment function determined using experimental data of an indentation to and retraction from substantially the sampling depth.

8. A method for determining an elastic ratio of indentation work of an indentation of a material surface to a sampling depth, the method comprising:
receiving load curve data that represent a load force measured on an indenter probe indenting the material surface up to a maximum depth greater than the sampling depth, in dependence on a depth indented to;
receiving unload curve data that represent an unload force measured on the indenter probe while retracting from the material surface from the maximum depth, in dependence on a depth retracted to;
calculating the elastic ratio of indentation work for the sampling depth from the received data.

9. The method of claim 8, wherein the elastic ratio of indentation work for the sampling depth is calculated from the load curve data and unload curve data in an interval up to the sampling depth.

10. The method of claim 8, the step of calculating the elastic ratio of indentation work comprising:
determining an overall indentation work by determining an area below the load curve in an interval up to the sampling depth;
determining an elastic indentation work by determining an area below the unload curve in the interval up to the sampling depth; and
calculating the elastic ratio of indentation work for the sampling depth by dividing the elastic indentation work by the overall indentation work.

11. The method of claim 8, further comprising shifting the unload curve along a depth axis such that the unload curve intersects the load curve at the sampling depth.

12. The method of claim 8, further comprising shifting the unload curve along a force axis such that the unload curve intersects the load curve at the sampling depth.

13. The method of claim 12, further comprising:
determining a residual depth at which the non-shifted unload curve reaches a depth axis; and
extrapolating the shifted unload curve in an interval up to the residual depth, down to the depth axis.

14. A computer program product comprising computer executable instructions that when executed on a computer cause the computer to perform the method of claim 8.

15. A nanoindenter for determining an elastic ratio of indentation work of an indentation of a material surface to a sampling depth, the nanoindenter comprising:
an indenter probe for placement on the material surface;
an indentation force drive for exerting a vertical force on the probe;
a controller unit for increasing the force until indentation of the material surface by the probe to a maximum depth greater than the sampling depth, and for decreasing the force to retract the probe from the maximum depth;
a recorder unit for recording the force as a first function of depth during the indentation, and for recording the force as a second function of depth during the retraction; and
a calculation unit for calculating the elastic ratio of indentation work for the sampling depth from the recorded functions.

16. The nanoindenter of claim 15, wherein the calculation unit is configured to calculate the elastic ratio of indentation work for the sampling depth from the first and second functions in an interval up to the sampling depth.

17. The nanoindenter of claim 15, wherein the calculation unit comprises:
means for determining an overall indentation work by integrating the first function in an interval up to the sampling depth;
means for determining an elastic indentation work by integrating the second function in the interval up to the sampling depth; and
means for calculating the elastic ratio of indentation work for the sampling depth by dividing the elastic indentation work by the overall indentation work.

18. The nanoindenter of claim 15, further comprising a function modification unit for modifying the second function of depth, the function modification unit comprising:
means for determining a sampling depth indentation force by evaluating the first function at the sampling depth;
means for determining a sampling retraction depth at which the second function evaluates to the sampling depth indentation force;
means for redefining the second function of depth such that it evaluates to the force value of the unmodified second function after a difference of the sampling depth and the sampling retraction depth is added to the depth.

19. An apparatus for determining an elastic ratio of indentation work of an indentation of a material surface to a sampling depth, the apparatus comprising:
a load curve data input unit for inputting load curve data that represent a load force measured on an indenter probe indenting the material surface up to a maximum depth greater than the sampling depth, in dependence on a depth indented to;
an unload curve data input unit for inputting unload curve data that represent an unload force measured on the indenter probe while retracting from the material surface from the maximum depth, in dependence on a depth retracted to;
a calculation unit for calculating the elastic ratio of indentation work for the sampling depth from the inputted data.

20. The apparatus of claim 19, wherein the calculation unit is configured to calculate the elastic ratio of indentation work for the sampling depth from the load curve data and unload curve data corresponding to an interval up to the sampling depth.

21. The apparatus of claim 19, further comprising an unload curve shifting unit for shifting the unload curve such that the unload curve intersects the load curve at the sampling depth.

22. The apparatus of claim 21, wherein the unload curve shifting unit is configured to shift the unload curve along a force axis.

23. A computer program product comprising computer executable instructions that when executed on a computer that is connected to a nanoindenter for indenting a material surface by an indenter probe are operational to cause the computer to perform the following steps:
controlling the nanoindenter to increase a vertical force on the probe until the material surface is indented to a maximum depth greater than the sampling depth;
acquiring force data during the indentation as a first function of depth, from the nanoindenter;
controlling the nanoindenter to retract the probe from the maximum depth while decreasing the force on the probe;
acquiring force data during the retraction as a second function of depth, from the nanoindenter; and
calculating the elastic ratio of indentation work for the sampling depth from the acquired data.

24. The computer program product of claim 23, comprising further instructions operational to cause the computer to further shift the second function of depth along the depth axis such that it evaluates to the same force as the first function at the sampling depth.

25. The computer program product of claim 23, comprising further instructions operational to cause the computer to further perform the following steps:
repeating the step of calculating the elastic ratio of indentation work for different values of the sampling depth less than the maximum depth; and
outputting the elastic ratio of indentation work as a function of sampling depth.
